(19) United States
(12) Patent Application Publication
(10) Pub. No.: US 2026/0116023 A1
(43) Pub. Date: Apr. 30, 2026

(54) METHOD FOR MANUFACTURING A TANK MADE OF COMPOSITE MATERIAL

(71) Applicant: ARIANEGROUP SAS, LES MUREAUX (FR)

(72) Inventors: Frédérick CAVALIERE, LE HAILLAN (FR); Cécile LESAMBER, LE HAILLAN (FR); Erwann LE GOFF, LE HAILLAN (FR)

(21) Appl. No.: 19/471,969

(22) PCT Filed: Apr. 1, 2024
(86) PCT No.: PCT/FR2024/050423

§ 371 Date: Oct. 2, 2025

(30) Foreign Application Priority Data
Apr. 3, 2023 (FR) FR2303251

(51) Int. Cl. B29C 70/44; B29K 63/00; B29K 105/08; B29L 31/00

(52) U.S. Cl. CPC B29C 70/446; B29K 2063/00; B29K 2105/0872; B29L 2031/7156

(57) ABSTRACT

A method of manufacturing a tank made of composite material in which a precursor assembly made of preimpregnated thermosetting fibrous material is vacuum cured in a tool whose molding parts are external to the assembly in order to facilitate subsequent demolding. The assembly includes a body-precursor cylinder closed by two bottom-precursor domes which are secured to the cylinder by co-curing.

### TECHNICAL FIELD

The present disclosure concerns a method of manufacturing a tank made of composite material, particularly suitable for manufacturing a tank of large dimensions, in particular having a great length. The invention finds particular interest in the manufacture of tanks intended to equip space launchers but is not limited to this application.

### PRIOR ART

Composite materials provide a savings in mass compared to metal materials, which is of particular interest in aerospace and aeronautical applications with a view to improving performance.

The recent development of reusable launchers is accompanied by the desire to continue developing lighter structures insofar as it is necessary to retain a certain quantity of propellants for the return of the stage to Earth, which leads to the loading of additional mass.

In current techniques for manufacturing tanks of composite material, the part is draped on a rotary mandrel, by winding or by the technique of automatic fiber placement (AFP). These techniques provide satisfactory results when the tanks have limited dimensions, but they can be improved for the manufacture of large tanks, typically having a length of 20 to 30 meters and a diameter of several meters.

In fact, particularly long mandrels may not have the rigidity required to maintain their shape during draping, especially due to bending under their own weight or when they are supporting the head of a draping robot. This can generate draping accuracy problems that can lead to defects in the structure.

The mandrels need to be dismantled and removed through small openings in the tank bottoms at the ends. Typically, a mandrel of 5 or 6 meters in diameter must be extracted through an opening of 1 meter in diameter or less. The larger the tank, the more complex the dismantling will be, with the associated risks of damage to the composite structure (shocks that can create damage to the structure). This will generate significant costs because complex specific tools will have to be designed for dismantling through these small openings. In addition, in certain cases, it is necessary to position a vacuum bag around the part draped on the mandrel and to carry out vacuum polymerization. It is then necessary to ensure a seal between the different parts constituting the removable mandrel, in order not to affect the material health. However, the longer the tool, the more junctions there will be to seal, with the potential problems of associated air leaks. In addition, the larger the tanks, the longer it will take to carry out the draping and the installation of the vacuum bag, and these operations must be carried out within a certain period of time not exceeding the open time at room temperature of the material indicated by the supplier.

It is also desirable to reduce the duration of the manufacturing cycle insofar as the draping tool also serves as polymerization tool, which makes it necessary to wait until the end of this step and the dismantling of the structure before being able to drape again.

The limits of the current techniques are even more marked when it comes to integrating reinforcing elements, such as stiffeners, or interface parts into the tank. US 2021/245447 discloses a method for manufacturing a high-pressure tank.

It is therefore desirable to have a method for manufacturing a tank made of composite material that deals with all or some of the above-mentioned disadvantages.

### DISCLOSURE OF THE INVENTION

The invention also concerns a method for manufacturing a tank made of composite material, comprising:
positioning a precursor assembly of the tank to be manufactured in a vacuum molding tool,
the assembly being made of thermosetting preimpregnated fibrous material and comprising (i) a sectorized cylinder, precursor of the body of the tank, extending along a longitudinal axis and formed by panels juxtaposed around the longitudinal axis with overlap between the adjacent panels, and (ii) two domes, precursors of the bottom of the tank, each of these domes being situated on the side of an opposite longitudinal end of the cylinder, the domes delimiting with the cylinder an internal volume of the tank to be obtained, each dome defining a cylindrical junction zone facing the cylinder and inside the latter,
the tool comprising an internal part lined with a vacuum bag, situated inside the internal volume, on which the assembly is positioned, and an external molding part, situated outside the internal volume, and comprising (a) a molding portion of the tank body having a cylindrical shape facing the precursor cylinder, and (b) molding portions of a dome-shaped tank bottom each facing a distinct bottom-precursor dome, and
vacuum curing of the assembly in the tool during which the vacuum bag applies pressure to shape the assembly on the molding portions, while holding the junction zones in abutment on the precursor cylinder and co-curing the domes and the cylinder to secure the bottoms to the body and obtain the composite material tank.

In the invention, the molding part is external to the precursor assembly, and therefore to the composite tank obtained. This external positioning makes it easier to dismantle with respect to the internal mold mandrel of the prior art and to more easily guarantee the tightness required for the vacuum draw. Unlike the mandrel of the prior art, the internal part in the invention has only a positioning function and not a molding function and therefore has a much simpler design and is more easily dismantled. If necessary, the molding portion of the body may be provided with stiffeners on its face opposite the assembly in order to preserve its shape despite a substantial length, without affecting the quality of the molding or the ability to be dismantled.

Co-curing makes it possible to polymerize the thermosetting resin impregnating the panels with that impregnating the domes, and to create covalent bonds between the polymer chains present. This joint polymerization joins the bottoms to the body of the composite material tank without requiring the addition of a third adhesive compound.

In an exemplary embodiment, the adjacent panels are thinner on their overlapping zone in the direction of their longitudinal edges.

Such a characteristic helps to further minimize misalignments and stress concentrations in the tank.

In one embodiment, the precursor domes are thinner in their cylindrical junction zones in the direction of a circumferential edge of the dome.

Such a characteristic helps to further minimize misalignments and stress concentrations in the tank.

In one embodiment, the precursor domes are each sectorized and formed by petals juxtaposed around the longitudinal axis with overlap between the adjacent petals.

Sectorizing the domes further improves their conformation during vacuum curing by allowing relative sliding between the petals.

In particular, adjacent petals may be thinner in their overlap zone in the direction of their longitudinal edges.

Such a characteristic helps to further minimize misalignments and stress concentrations in the tank.

In one embodiment, the panels and domes are assembled in the semi-cured state to form the precursor assembly. Thus, the panels and domes, already formed, can be assembled in the semi-cured state to form the precursor assembly, or else the panels and petals, intended to form the domes after juxtaposition, can be assembled in the semi-cured state to form the precursor assembly.

A semi-cured thermosetting material has a partially polymerized resin that has a degree of polymerization progress comprised between 15% and 70%, for example between 25% and 50%. For a given resin, the degree of polymerization progress can be determined by differential scanning calorimetry (DSC).

A semi-cured material has a certain rigidity at room temperature (20° C.) which facilitates its handling and allows the tools to be simplified. Its use also makes it possible to be less constrained by the open time at room temperature of the material because the polymerization of a semi-cured material changes very little at room temperature. The resin of a semi-cured material regains fluidity when the material rises in temperature during vacuum curing, allowing the elements to soften and conform with the molding portions.

In an exemplary embodiment, the panels and the domes each comprise a plurality of stiffeners on a face opposite the molding portions.

The external character of the molding tool does not interfere with the presence of stiffeners. The invention therefore finds particular interest in the manufacture of a stiffened tank which may be relatively difficult to obtain in the techniques of the prior art using an internal molding mandrel.

In an exemplary embodiment, the method further comprises, before positioning the precursor assembly in the molding tool, forming the panels and domes by automatic fiber placement, the panels and domes each being draped on a form distinct from the internal positioning part.

This technique allows access to a wide variety of geometries, especially compared to winding which does not allow draping in the direction of the longitudinal axis, or automated draping of local increased thicknesses or reinforcements. Automatic fiber placement also makes it possible to obtain elements of low permeability compared to parts obtained by winding, suitable for example, for the storage of cryogenic propellants. In addition, the draping tool is separated from the polymerization tool, which reduces the manufacturing cycle time.

In one embodiment, the cylinder extends beyond each of the domes so as to define front and rear skirt precursors.

Such a characteristic is of particular interest in the context of a tank intended to equip an aerospace launch vehicle, by allowing the skirts to be integrated in a single piece with the tank, thus making it possible to form a complete launch vehicle stage in a simplified manner.

In particular, each of the domes may define a second cylindrical junction zone facing a respective skirt precursor and which may be secured to the latter during vacuum curing.

In one embodiment, the panels and domes comprise carbon fibers, glass fibers, aramid fibers, or a mixture of such fibers.

These fiber materials are particularly suitable for space launcher applications and cryogenic environments.

In one embodiment, the panels and the domes are preimpregnated with an epoxy resin, for example a class 180 epoxy resin which polymerizes at a temperature comprised between 175° C. and 185° C., for example substantially at 180° C.

This material is particularly suitable for space launcher applications and cryogenic environments, and can be easily reworked after partial polymerization.

### BRIEF DESCRIPTION OF THE DRAWINGS

FIG. 1 schematically shows in perspective an example of a panel that can be used in the context of the invention.

FIG. 2 schematically and partially shows a cross-section of the panel of FIG. 1 with respect to its longitudinal axis.

FIG. 2A schematically and partially shows the bevel angle of the panel in FIG. 2.

FIG. 3 schematically shows in perspective the overlapping of two adjacent panels according to an example of implementation of the invention.

FIG. 4 schematically and partially shows a variant of a sectorized cylinder.

FIG. 5 schematically and partially shows another variant of a sectorized cylinder.

FIG. 6 schematically and partially shows another variant of a sectorized cylinder.

FIG. 7 schematically and partially shows another variant of a sectorized cylinder.

FIG. 8 shows an example of a petal intended to form a bottom-precursor dome by juxtaposition with other petals.

FIG. 9 shows the juxtaposition of a second petal on the petal of FIG. 8 according to an example of implementation of the invention.

FIG. 10 schematically and partially shows a sectional view of the dome resulting from the juxtaposition of petals according to FIG. 8 in a plane containing the height of the dome.

FIG. 11 schematically and partially shows a sectional view of the dome resulting from the juxtaposition of petals according to FIG. 8 in a plane perpendicular to the height of the dome.

FIG. 12 schematically and partially shows a precursor assembly of the tank to be manufactured positioned in a vacuum molding tool in the context of an example of implementation of the invention.

FIG. 13 schematically and partially shows the stiffeners present in the assembly of FIG. 12.

FIG. 14 schematically shows the vacuum curing of the assembly shown in FIG. 12.

FIG. 15 schematically shows a detail of a bottom-precursor dome variant.

### DESCRIPTION OF THE EMBODIMENTS

The invention will now be described by means of figures, which are present for descriptive purposes to illustrate certain embodiments of the invention and which should not be interpreted as limiting it.

The description below addresses, first, the structure and obtaining of the body-precursor cylinder, as well as the bottom-precursor domes. The details of the vacuum molding tool, inside which the precursor assembly is positioned, as well as the vacuum curing phase will be discussed in a second step.

### Panels and Body-Precursor Cylinder

The body-precursor cylinder is obtained by juxtaposition of thermosetting preimpregnated fibrous panels. In general, it may comprise at least two fibrous panels, or even at least three fibrous panels. The example described here concerns the case of a four-panel cylinder.

The panels are advantageously made by automatic fiber placement, which constitutes a technique known per se. The panels 10 each comprise a fibrous reinforcement preimpregnated with a thermosetting resin. The choice of reinforcing material and resin depends on the intended application. By way of example, the fibrous reinforcement comprises carbon fibers, glass fibers, aramid fibers, or a mixture of such fibers. By way of example, the resin is an epoxy resin, for example based on a bisphenol A diglycidyl ether (DGEBA) monomer, triglycidyl-para-aminophenol (TGPAP) monomer, or tetraglycidyl methylene dianiline (TGMDA) monomer, to which an amine type hardener may optionally be added, for example diaminodiphenyl sulfone (DDS). Advantageously, the same resin is used in the different panels, or, failing that, compatible resins are used.

The panels 10 have an elongated shape along a longitudinal X axis and have a curved shape in cross section with respect to the X axis. The panels 10 define two longitudinal edges 10a, 10b which are intended to be superposed with an adjacent panel, as will be described hereinafter. As indicated above, the invention finds particular interest in the manufacture of tanks of substantial length. Thus, the panels 10 may have a length LO10 of at least 10 meters, for example of at least 20 meters, in particular comprised between 20 meters and 30 meters. FIG. 1 illustrates an example of a possible structure for the panels 10 which are draped in a female tool; the person skilled in the art will recognize that the panels can alternatively be draped on a male tool without exceeding the scope of the present invention. The draping form is not an integral part of the vacuum molding tool so it allows simultaneous draping and curing operations, thus reducing the manufacturing cycle time.

The panels 10 are, in the example of FIG. 1, provided with longitudinal stiffeners 12 made of thermosetting composite. These stiffeners 12 are formed by conventional means known to the person skilled in the art, for example by manual or automated draping, draping in a shaped mold or stamping in a press of flat green plates, creating dry preforms and injecting resin into a mold by a resin transfer molding (RTM) technique. The stiffeners 12 may have any cross-section, for example omega-, T- or J-shaped, among other possible shapes. The stiffeners 12 may or may not have a local variation in shape or section. As illustrated, the stiffeners 12 may be present over at least the majority (more than 50%), or even at least 80%, of the length LO10 of the panels 10. The panels 10 nevertheless have zones devoid of stiffening elements which will be described hereinafter,

The panels 10 shown are also provided with circumferential frame sectors 14 made of thermosetting composite. As for the stiffeners 12, the frame sectors 14 are formed in a manner known per se. The frame sectors 14 may have any cross-section, for example Z-, C-, F-, T-, omega- or J-shaped.

The stiffeners 12 and frame sectors 14 may be semi-cured, or may have complete polymerization, or may have little or no polymerization.

The panels 10 have circumferential zones 16 intended for docking with the bottoms, which are devoid of stiffening elements. The zones 16 are each situated on the side of an opposite longitudinal end of the panel 10 considered and on either side of a zone 18 provided with stiffeners 12 and frame sectors 14. As will be detailed below, the bottoms will be secured to the body of the tank over these zones 16. The panels 10 also have a longitudinal zone 19, situated on the side of the longitudinal edge 10b and extending over their entire length LO10, which is devoid of any stiffening elements. It will also be noted that, in the example illustrated, the frame sectors 14 project from the panel 10 on the side opposite the zone 19 (on the side of the edge 10a) and form an extension 15 of the frame sectors 14. The presence of the zone 19 as well as the extension of the frames 14 are the result of the arrangement envisaged for the overlap between adjacent panels 10.

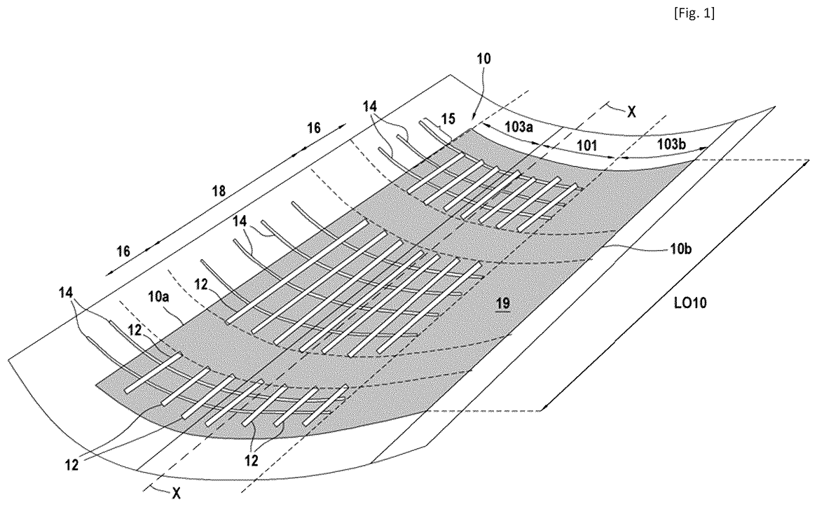

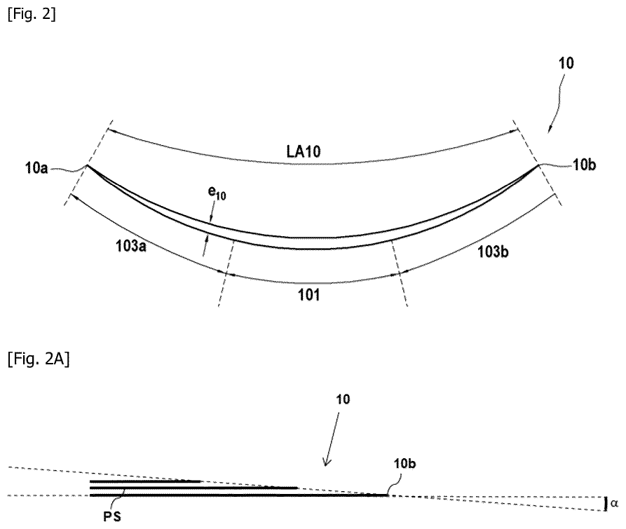

FIG. 2 shows the evolution of the thickness e10 of the panels 10 over their width (dimension between the edges 10a and 10b). The panels 10 have a middle zone 101 of their width where the thickness e10 is substantially constant, and two lateral zones 103a and 103b each situated on the side of a respective longitudinal edge 10a, 10b which have a varying thickness. The zone 101 is situated between the zones 103a, 103b. The zone 103a connects the zone 101 to the edge 10a, and the zone 103b connects the zone 101 to the edge 10b. More precisely, the zones 103a, 103b become thinner in the direction of the associated longitudinal edge 10a, 10b. The thickness e10 may decrease strictly in the direction of the longitudinal edge 10a, 10b. The thickness e10 is minimum on the edges 10a, 10b and maximum on the middle zone 101. The panels 10 have a bevel on their edges 10a, 10b, in cross-section, the panels 10 have a shape that tapers toward their edges 10a, 10b with respect to the X axis. The zones 103a and 103b together occupy at least 5%, for example at least 50%, of the width LA10 of the panel 10. Unless otherwise stated, the width LA10 corresponds to the length of the arc of a curve connecting the edge 10a to the edge 10b. The reduction of the thickness leads to a thickness e10 decrease of at least 50%, for example of at least 90%. This thickness e10 decrease is, for example, comprised between 50% and 95%, or even between 90% and 95%. FIG. 2A schematically shows a reduction in the thickness of the panel 10 in the direction of a longitudinal edge 10b associated with the presence of a decreasing quantity of superimposed folds PS in the direction of the edge 10b. The angle α of the bevel, corresponding to the angle taken locally on the edge 10b, can advantageously be less than or equal to 1.5°, so as to further improve the smoothing of the forces.

The panels 10 that have just been described comprise stiffening elements, but it would not be exceeding the scope of the invention if they are devoid of these elements.

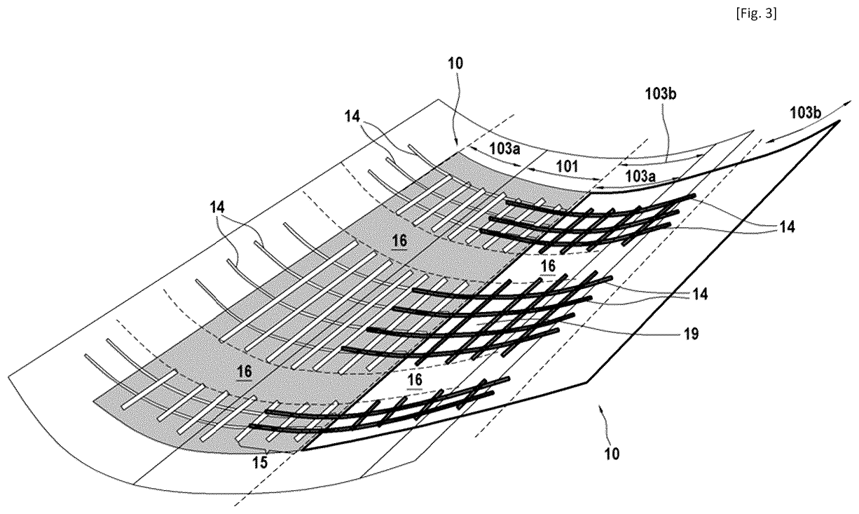

With reference to FIGS. 3 to 7, the following describes the juxtaposition of these panels 10 to form the sectorized cylinder 100 which is, in the example considered, the precursor of the tank body but also of front and rear skirts which extend beyond the bottoms.

FIG. 3 illustrates the juxtaposition of two adjacent panels 10 around the X axis. The two panels 10 illustrated have the same structure and the same references are retained with respect to what has just been described. The panels 10 partially overlap here. The panels have a reduced thickness in their overlap zone, that is to say that zone the 103b of the first panel 10 is covered by the zone 103a of the adjacent second panel 10. The edge 10b of the first panel 10 is superposed with the adjacent second panel 10, and the edge 10a of the second panel 10 is superposed with the first panel. The stiffeners 12 and frame sectors 14 of the second panel 10 cover the zone 19 of the first panel 10. The extension 15 of the frame sectors 14 of the second panel 10 extends over the zone 101 of the first panel and is positioned adjacent to and in the extension of the frame sectors 14 of the first panel. The extension 15 of the second panel 10 is assembled with the frame sectors 14 of the first panel 10 by techniques known per se, for example by overlapping, joggling or splicing, In addition, the zones 16 of the first panel 10 are in the extension of the zones 16 of the second panel 10.

The arrangement which has just been described can be applied to each pair of adjacent panels 10 juxtaposed to form the sectorized cylinder. In general, the overlap zones between adjacent panels can occupy at least 5%, for example at least 30% of the perimeter of the sectorized cylinder. The fact of having spread-out overlapping zones makes it possible to further improve the mechanical properties of the tank obtained. In particular, when all the panels are assembled to form the sectorized cylinder, the joining of the zones 16 forms a 360° circumferential zone devoid of any stiffening elements. In addition, the joining of the frame sectors 14 of each of the panels defines a plurality of 360° circumferential frames distributed over the length of the cylinder,

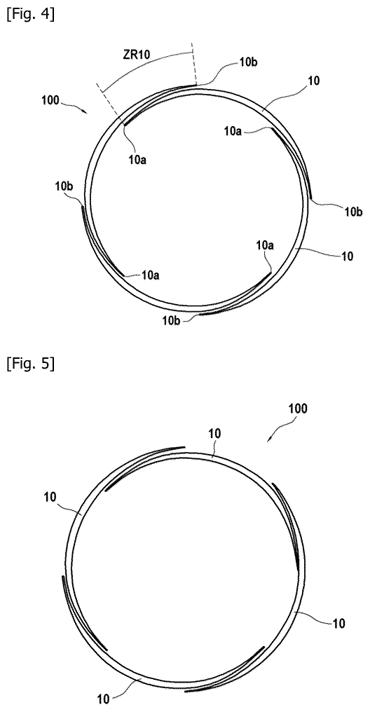

FIGS. 4 to 7 show different variants of juxtaposition of the panels 10 to form the sectorized cylinder 100. The cylinder 100 extends along the X axis with panels juxtaposed around this axis.

In the variant of FIG. 4, the cylinder 100 is formed by overlapping all the panels 10 in a tiled manner, i.e. each of the panels has a first longitudinal edge 10b overlapping (above) a first adjacent panel, and a second longitudinal edge 10a opposite the first edge 10b overlapped (below) by a second adjacent panel opposite the first adjacent panel. Note in particular the reduced thickness of the adjacent panels 10 over their overlap zone ZR10 in the direction of their longitudinal edges 10a, 10b.

In the variant of FIG. 5, the panels overlap in a tiled manner except for the panel 10 at the bottom right of the figure which overlaps its two adjacent panels.

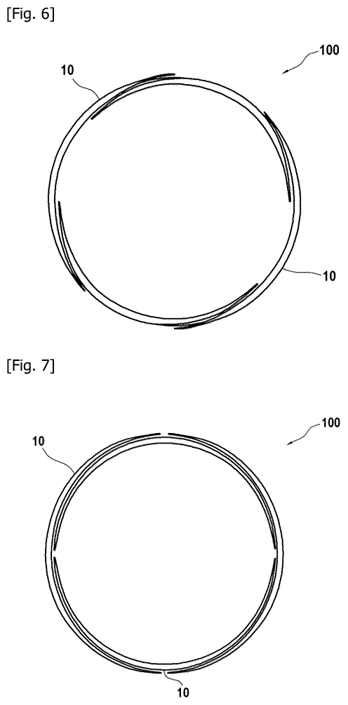

The variants of FIGS. 6 and 7 show cases where there is no overlap which are also covered by the present invention.

The part that has just been described concerns the panels and their juxtaposition to form the body-precursor cylinder. The remainder relates to the bottom-precursor domes which are intended to be secured to the cylinder in order to delimit the internal volume of the tank made of composite material to be obtained.

### Bottom-Precursor Domes

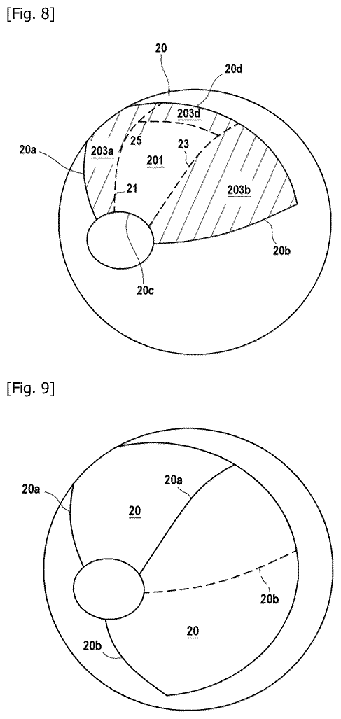

FIG. 8 shows a petal 20, which has the shape of a dome sector, shaped by draping. According to this example, each bottom-precursor dome is obtained by juxtaposition of thermosetting preimpregnated fibrous petals 20. In general, each of the domes may comprise at least two petals 20, or even at least three petals 20. The example described here concerns the case of domes each having four petals 20.

As for the panels 10, the petals 20 are advantageously created by automatic fiber placement. The petals 20 each comprise a fibrous reinforcement preimpregnated with a thermosetting resin. The choice of reinforcing material and resin depends on the intended application. The reinforcement and resin of the petals 20 may be as described above for the panels 10. Advantageously, a resin identical to that of the panels 10 will be chosen for the petals 20, or, failing that, a resin compatible with it. Similarly to the panels 10, the petals 20 can be draped on a male or female tool, and on a draping form that is not an integral part of the vacuum molding tool.

As for the panels 10, the petals 20 define two edges 20a, 20b each extending along a longitude, called longitudinal edges, which are intended to be superposed with an adjacent petal. The longitudinal edges 20a, 20b are intended to extend along the longitudinal X axis of the cylinder 100 in the precursor assembly which will be described below. The petals 20 define two edges 20c, 20d each extending along a latitude (or circumferential) which are transverse to the edges 20a, 20b. Each of the edges 20c, 20d connects the edge 20a to the edge 20b. The edge 20c has a first curvilinear length, and the edge 20d has a second curvilinear length that is greater than the first curvilinear length.

In a manner similar to the panels 10, and as illustrated in FIG. 2, the petals 20 have a varying thickness between the edges 20a and 20b. The petals 20 thus have a middle zone 201 where the thickness is substantially constant, and two lateral zones 203a and 203b each situated on the side of a respective edge 20a, 20b which have a varying thickness, The zone 203a is delimited by the edge 20a and the longitude 21 and the zone 203b by the edge 20b and the longitude 23. The zone 201 is situated between the zones 203a and 203b, or between the longitudes 21 and 23. The description given above relating to zones 103a, 101 and 103b applies respectively to zones 203a, 201 and 203b with the relevant changes made.

The petals 20 define a sector 203d of a cylindrical junction zone which is intended to face the body-precursor cylinder, and more particularly facing the docking zone 16 which has been described above. The sector 203d corresponds to a circumferential zone delimited by the edge 20d and by a latitude 25. In the example described here and as illustrated in FIG. 10, the petals 20 have a reduced thickness in their sector 203d in the direction of the edge 20d.

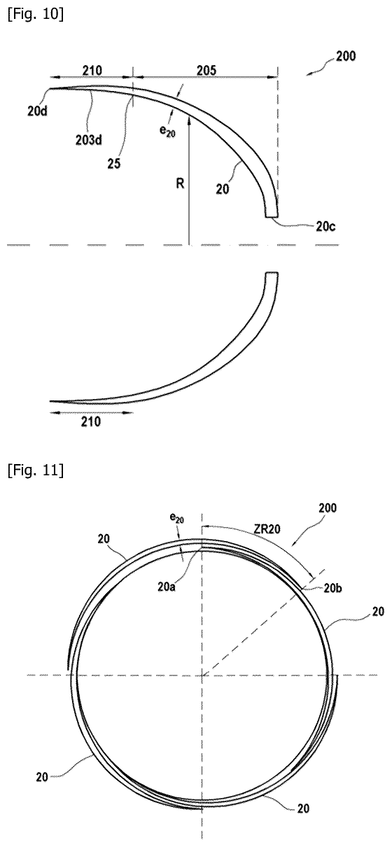

The petals 20 are juxtaposed at their edges 20a, 20b with overlapping between adjacent petals, in a manner similar to that described above for the panels 10. Thus, FIG. 9 shows the positioning of a second petal 20 in partial overlap with the first petal 20, it being understood that two other petals are juxtaposed to form the complete dome 200 in the example considered. FIG. 11 schematically shows the juxtaposition of these four petals 20. The adjacent petals 20 here have a reduced thickness e20 over their overlap zone ZR20 in the direction of their longitudinal edges 20a, 20b.

As illustrated in FIG. 10, the dome 200 has a bottom zone 205 situated between the edge 20c and the latitude 25. The dome 200, and in particular the zone 205, has a shape of revolution. The joining of the sectors 203d forms a 360° cylindrical junction zone 210 which extends the zone 205 as far as the edge 20d. FIG. 10 shows the reduced thickness e20 of the petals 20 (or of the dome 200) in the direction of the edge 20d, at the sectors 203d or at the zone 210. The evolution of the radius R of the dome 200 is also visible with a radius R strictly increasing between the edge 20c and the latitude 25, and substantially constant over the zone 210. The radius R of the dome 200, taken from the edge 20d, may be greater than or equal to 1 meter, for example greater than or equal to 2.5 meters.

It will also be noted that the petals 20 may be provided with stiffeners made of thermosetting composite. The description given above for these stiffeners in connection with the panels 10 is applicable. A possible illustration of these stiffeners is given in FIG. 13 which will be described hereinafter.

A possible structure for the cylinder 100 and the domes 200 has just been described. The following describes their assembly and positioning in the vacuum molding tool.

### Assembly of the Vacuum Molding Tool and Positioning of the Precursor Assembly in this Tool

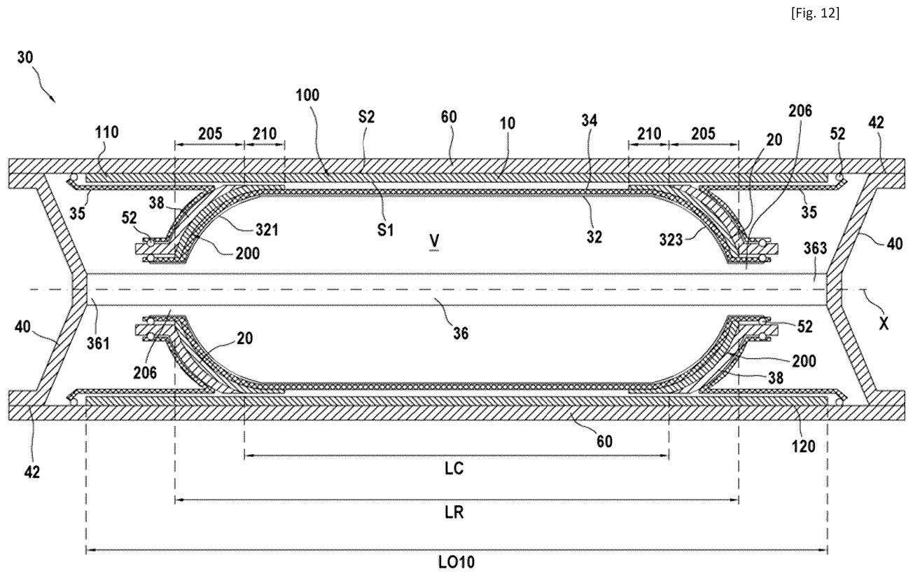

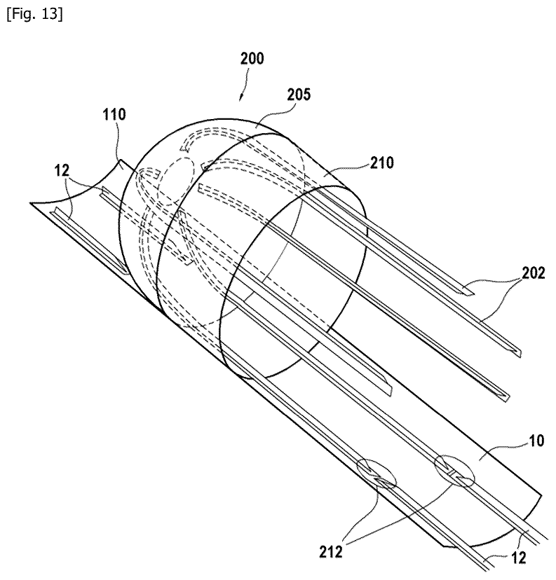

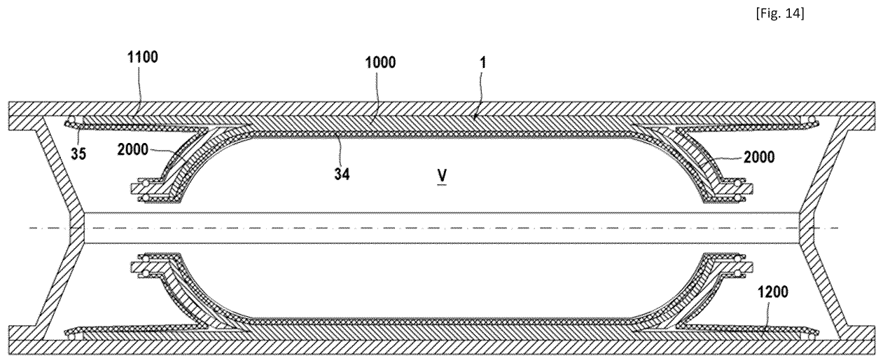

The kinematics of the assembly of the vacuum molding tool 30 and positioning of the precursor assembly will now be detailed in relation to FIG. 12. In this figure, as well as in FIG. 14, the relative thicknesses as well as the spacings between the different elements have not been strictly respected for reasons of readability.

A vacuum bag 34 is initially placed on a positioning part 32. The part 32 is of much simpler design than the mandrel used in the techniques of the prior art insofar as it is not used as a molding surface and does not need to be sealed. It is therefore more easily dismantled. The part 32 is supported by a shaft 36 which extends along a longitudinal X axis. The X axis corresponds to the longitudinal axis of the panels 10 and of the cylinder 100 which has been described above. The part 32 may have an aerated structure, for example a lattice structure, or may have a plurality of retractable positioning elements fixed to the shaft. The part 32 may, as illustrated, generally have the shape of the tank to be obtained. The bag 34 covers the part 32. The bag 34 may be composed of elastomer material, optionally reinforced, and constitutes an element known per se.

The petals 20 are then positioned on the part 32 at its two opposite longitudinal ends 321 and 323. The petals 20 are juxtaposed in the manner described above to form two bottom-precursor domes 200 at opposite ends 321, 323. The bottom zones 205 of the domes 200 each define an orifice 206, here in the general shape of a disk, through which the shaft 36 extends. The domes 200 may have a general shape of revolution about the X axis.

The molding portions 38 are then positioned. These portions 38 each have the shape of a dome and are in the shape of the bottoms of the tank to be obtained. The example illustrated shows two symmetrical portions 38 but, of course, it is not beyond the scope of the invention if this is not the case. The domes 200 are situated inside the interior volume defined between the portions 38. Each dome 200 is held in place by a respective portion 38. Each dome 200 is inserted between a portion 38 and the vacuum bag 34 (or the part 32), As illustrated, the portions 38 cover the bottom zone 205 but do not cover the cylindrical junction zone 210. The person skilled in the art will recognize that other variants are possible. Thus, the domes 200 can first be positioned on the portions 38 and then this assembly can then be placed on the ends 321, 323 of the part 32. The shaft 36 precisely positions the portions 38 and holds them in place. According to a variant, all the petals can first be draped on a dome tool, then the dome can be semi-cured before assembly on the part 32 or the portion 38.

In the example considered in FIG. 12, a second and a third vacuum bag 35 are then placed respectively for the formation of the front and rear skirts which will be described hereinafter. The second and third bags 35 may have the same nature as the first bags 34.

Positioning rings 40 are then positioned at the ends 361, 363 of the shaft 36 which define a cylindrical positioning surface 42 whose function will be described below.

The panels 10 are then positioned and juxtaposed, in the manner described above, so as to form the body-precursor cylinder 100 of the tank. The cylinder 100 is situated around the domes 200. In the example illustrated, the domes 200 are situated inside the cylinder 100. The cylinder 100 extends from one dome 200 to another. In general, the length LO10 of the panels, which also corresponds to the length of the cylinder 100, is greater than or equal to the length LC, measured along the X axis, which corresponds to the distance separating the two zones 205. The length LC substantially corresponds to the length of the body of the tank to be obtained. In the example illustrated, the cylinder 100 extends beyond the domes 200 to form front skirt precursors 110 and rear skirt precursors 120 positioned respectively facing the second and third bags 35. Thus, in this example, the length LO10 is greater than the length LR, measured along the X axis, which corresponds to the distance between the orifices 206 of the domes 200. The length LR substantially corresponds to the length of the composite tank to be obtained. However, it would not exceed the scope of the invention if the cylinder did not form such skirts by stopping at the domes 200.

Thus, after positioning the panels 10, a precursor assembly of the tank to be manufactured is obtained which comprises the cylinder 100 and the domes 200 each situated on the side of an opposite longitudinal end of the cylinder 100. The domes 200 delimit with the cylinder 100 an internal volume V of the tank to be obtained. The domes 200 close the cylinder 100 on the side of each of its longitudinal ends. The cylinder 100 and the domes are each made of thermosetting preimpregnated fibrous material. The panels 10 are positioned facing the zones 210 so as to enable the bottoms to be secured to the body during the co-curing which will be described below. In particular, the zones 210 face the zones 16 of the panels 10 devoid of stiffening elements and which have been described above.

The panels 10 and domes 200 (or petals 20) can be assembled in the semi-cured state to form the precursor assembly. They can each be draped, during their manufacture, in the semi-cured state, or alternatively be draped in the raw state, that is to say with a degree of polymerization progress lower than that of the semi-cured state and then undergo a partial polymerization heat treatment to bring them to the semi-cured state. The domes 200 (or petals 20) and the panels 10 can be assembled after this partial polymerization.

The molding portion 60 of the body of the tank is then positioned, which portion is in the shape of the body of the tank to be obtained and which surrounds the cylinder 100 over its entire length. The cylinder 100 is situated inside the portion 60. The portion 60 is situated around the cylinder 100. The portion 60 makes it possible to hold the panels 10 in place. It is possible to envisage indexing the panels 10 on the portion 60. Like the panels 10, the portion 60 can be sectorized and formed by several sectors assembled together to form a 360° molding portion. As illustrated, the portion 60 extends from one ring 40 to the other. It is positioned on the surface 42, which avoids having to support the weight of this external tool on the panels 10. The portion 60 may comprise stiffeners (not shown) on its face opposite the panels 10 in order to have a high rigidity and thus retain the same shape, without bending, despite a substantial length. An internal surface S1 of the precursor assembly is situated on the side of the bag 34 (and delimits the internal volume V of the tank), and an external surface S2 of the assembly is situated on the side of the portions 38, 60.

FIG. 13 shows a possible detail relating to the stiffeners 12 of the panels 10 and to the stiffeners 202 of the assembled domes 200. The stiffeners 202 have a curved shape, here following the longitudes of each of the domes 200. The stiffeners 202 and 12 are situated on a face of the precursor assembly opposite the portions 38, 60. In the example illustrated, the stiffeners 202 extend beyond the domes 200 to extend along the panels when the cylinder 100 is assembled with the domes 200. The stiffeners 202 are joined to the stiffeners 12 at junction zones 212 by techniques known per se, for example by edge-to-edge junction, joggling or splicing, It does not exceed the scope of the invention if the stiffeners of the domes do not extend beyond the zone 210, or if the domes are devoid of stiffeners.

The seals 52 between the bag 34, 35 and the molding portions 38, 60 are then produced.

The precursor assembly is thus positioned in the vacuum molding tool 30. In particular, the cylinder 100 is interposed between the bag 34 and the molding portion 60, and each dome 200 is interposed between the bag 34 and a respective molding portion 38. The part 32 is situated inside the precursor assembly, that is to say it is situated inside the internal volume V of the tank to be obtained. The assembly of the portions 60 and 38 is situated outside this internal volume and forms a part external to the assembly, intended for molding the tank.

### Vacuum Curing of the Precursor Assembly in the Tool and Dismantling

The vacuum curing phase is illustrated in FIG. 14. This curing phase can be carried out with or without additional pressure.

The heating applied fluidizes the resin or resins present. Placing the tool 30 under vacuum causes the bag 34 to be pressed against the cylinder 100 and the domes 200 so as to press the dome against the portions 38, 60 and to conform them to the desired shape. The domes 200 are pressed against the panels 10 by means of the slight relative displacement/spacing of the petals 20, this spacing being made possible by means of the low viscosity of the resin in terms of temperature and the creep between the petals. During assembly with the panels 10, under the effect of temperature and pressure, the petals 20 move apart to conform to the internal surface of the panels. It is essentially the zone 210 that will dock with the panels 100. The bags 35 apply pressure to the skirt precursors 110 and 120.

Once all the parts are in place, the heating allows the resin to finish polymerizing with the creation of bonds at the polymer chains (creation of a three-dimensional network), freezing the interfaces and the overall shape of the tank structure. The polymerization of thermosetting materials is complete after the co-curing step.

Vacuum curing can be carried out in a heating chamber, such as an oven or an autoclave. The oven will allow vacuum polymerization; the autoclave will provide additional pressure beyond the vacuum draw. As a variant or in combination, it is possible to use a molding tool equipped with heating elements (not shown) to perform this curing. The temperature imposed during the vacuum curing depends on the resin used and may, for example, be greater than or equal to 150° C. and, for example, be comprised between 175° C. and 185° C., for example, close to 180° C.

A tool 30 made of composite material may be used to reduce the phenomenon of differential expansion between the tool and the tank. As a variant, the tool 30 may be metal, for example Invar or steel. In the latter case, it may be advantageous to minimize the stresses during cooling, for example by breaking the vacuum in the vacuum bag at the end of the polymerization stage, or by providing a partial opening of the portion 60.

The tool 30 is then dismantled, which is facilitated by the positioning of the molding portions outside the tank, and by the simplified design of the internal part.

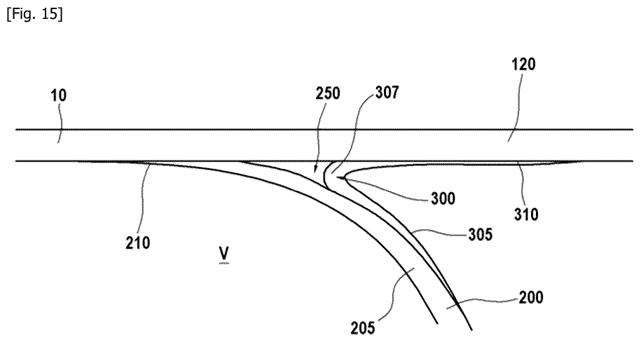

The tank 1 obtained which has just been described has a front skirt 1100 and a rear skirt 1200 extending the body 1000 beyond the bottoms 2000. The skirts 1100 and 1200 are of one piece with the rest of the tank 1. FIG. 15 illustrates a variant embodiment integrating into this context in which the dome has an additional junction on the skirt side by means of the use of a toroidal part which will now be described.

Thus, the dome 200 of FIG. 15 defines a second cylindrical junction zone 310 facing the skirt precursor 120, it being understood that a similar structure is present on the side of the skirt precursor 110. The second zone 310 is situated on the side opposite to the first zone 210. The first zone 210 delimits the internal volume V of the tank to be obtained, and the second zone 310 extends outside this volume V.

The second zone 310 is defined by a toroidal part 300 which is attached to the zone 205. More particularly, the part 300 comprises a zone 305 for joining the dome 200 taking the shape of the zone 205 and integral with this zone, the zone 310 facing the skirt precursor 120 and a folded intermediate zone 307 connecting the zone 305 to the zone 310.

The part 300 is made separately. In the same way as the bottom 200, it may be constituted by juxtaposed sectors formed by a thermosetting preimpregnated fibrous material, which partially overlap. The part 300 can be made by automatic fiber placement, or else manually in the case where the “fold” radius is too small to be made by AFP draping. Advantageously, the part 300 is semi-cured after draping and before assembly with the bottom 200 and the panels 10.

The part 300 is positioned on the bottom 200 once this bottom has been positioned on the part 32. Then, once in place, the portion 38 is positioned which has a shape adapted to the presence of the part 300. As a variant, the part 300 is first positioned on the portion 38, then the bottom 200 is positioned on this portion 38 and the assembly is placed on the part 32.

The part 300 may or may not be stiffened. The stiffeners may be as described above and are positioned in the tool prior to draping.

The space 250 between the dome 200 and the part 300 may be filled with a filling material, optionally containing fibers.

As for the tank bottom, during vacuum curing, the toroidal part will soften under the action of the temperature (decrease in the viscosity of the resin). And under the action of the pressure, applied by the bags 35, the diameter of the torus will slightly increase (relative spacing of the sectors of the torus) and come to conform to the internal surface of the panels. Once completely polymerized, the toroidal part is integral with the bottom and the panels and ensures a connection of the bottom to the front and rear skirts.

The invention which has just been described is particularly suitable for the manufacture of tanks of substantial length, or even very substantial length, which can be encountered in the case of tanks of the main stage of space launchers (lower stage), or in the case of tanks of powder acceleration stages (boosters). The invention also applies to tanks of the upper stages. In operation, the composite tank may be filled with liquid methane, liquid hydrogen or liquid oxygen, or a combination of these compounds. The tank can be used in a cryogenic environment.

However, the field of the invention is not limited to a tank for integration into an aerospace launch vehicle but can find an application in the aeronautical field or, more generally, in any application requiring a large tank.

The expression “comprised between . . . and . . . ” should be understood to include the bounds.

1. A method for manufacturing a tank made of composite material, comprising:
positioning a precursor assembly of the tank to be manufactured in a vacuum molding tool, the assembly being made of preimpregnated thermosetting fibrous material and comprising (i) a sectorized cylinder precursor of the body of the tank, extending along a longitudinal axis and formed by panels juxtaposed around the longitudinal axis with overlap between the adjacent panels, and (ii) two domes, precursors of the bottom of the tank, each of these domes being situated on the side of an opposite longitudinal end of the cylinder, the domes delimiting with the cylinder an internal volume of the tank to be obtained, each dome defining a cylindrical junction zone facing the cylinder and inside the latter,
the tool comprising an internal part lined with a vacuum bag, situated inside the internal volume, on which the assembly is positioned, and an external molding part, situated outside the internal volume, and comprising (a) a molding portion of the tank body having a cylindrical shape facing the precursor cylinder, and (b) molding portions of a dome-shaped tank bottom each facing a distinct bottom-precursor dome, and
vacuum curing of the assembly in the tool during which the vacuum bag applies pressure to shape the assembly on the molding portions, while holding the junction zones in abutment on the precursor cylinder and co-curing the domes and the cylinder together to secure the bottoms to the body and obtain the composite material tank.

2. The method according to claim 1, wherein the adjacent panels have a thinner part on their overlapping zone in the direction of their longitudinal edges.

3. The method according to claim 1, wherein the precursor domes have a thinner part on their cylindrical junction zones toward a circumferential edge of the dome.

4. The method according to claim 1, wherein the precursor domes are each sectorized and formed by petals juxtaposed around the longitudinal axis with overlapping between adjacent petals.

5. The method according to claim 4, wherein the adjacent petals have a thinner part on their overlapping zone in the direction of their longitudinal edges.

6. The method according to claim 1, wherein the panels and domes are assembled in the semi-cured state to form the precursor assembly.

7. The method according to claim 1, wherein the panels and domes each comprise a plurality of stiffeners on a face opposite the molding portions.

8. The method according to claim 1, wherein the method further comprises, prior to positioning the precursor assembly in the molding tool, forming the panels and domes by automatic fiber placement, the panels and domes each being draped on a form distinct from the positioning internal part.

9. The method according to claim 1, wherein the cylinder extends beyond each of the domes so as to define front and rear skirt precursors.

10. The method according to claim 9, wherein each of the domes defines a second cylindrical junction zone facing a respective skirt precursor and being secured thereto during vacuum curing.

11. The method according to claim 1, wherein the panels and domes comprise carbon fibers, glass fibers, aramid fibers, or a mixture of such fibers.

12. The method according to claim 1, wherein the panels and domes are preimpregnated with an epoxy resin.
